(19) United States
(12) Patent Application Publication
(10) Pub. No.: US 2026/0022736 A1
(43) Pub. Date: Jan. 22, 2026

(54) BUSHING FOR HEAVY-DUTY VEHICLE AXLE/SUSPENSION SYSTEMS

(71) Applicant: Hendrickson USA, L.L.C., Schaumburg, IL (US)

(72) Inventors: Andrew S. Pendlebury, Chelsea Heights (AU); Luke B. Callaway, Frankston (AU); Randy J. Zimmerman, Spencerville, IN (US); Kerry Yingling, Corunna, IN (US)

(21) Appl. No.: 19/266,345

(22) Filed: Jul. 11, 2025

Related U.S. Application Data
(60) Provisional application No. 63/672,391, filed on Jul. 17, 2024.

(51) Int. Cl. F16C 33/20; B29C 45/14; B29C 45/27; B29K 21/00; B29L 31/00; B60G 11/27

(52) U.S. Cl. CPC F16C 33/20; B29C 45/1459; B29C 45/2735; F16C 33/208; B29K 2021/003; B29L 2031/721; B60G 11/27; B60G 2204/41

(57) ABSTRACT

A bushing for heavy-duty vehicle axle/suspension systems and method of making the same. The bushing includes a body formed of an elastomeric material. The body is formed with a central opening that enables a suspension assembly incorporating the bushing to be pivotally connected to the heavy-duty vehicle. The body of the bushing is formed with at least one void that extends partially circumferentially about an inboard or an outboard side of the body and is asymmetrical relative to a vertical plane and a horizontal plane extending through a central pivotal axis extending through the central opening when the bushing is installed in a beam of the suspension assembly.

### CROSS-REFERENCE TO RELATED APPLICATION

This application claims the benefit of U.S. Provisional Patent Application Ser. No. 63/672,391 filed on Jul. 17, 2024.

### BACKGROUND

### Technical Field

The disclosed subject matter relates to axle/suspension systems for heavy-duty vehicles. More particularly, the disclosed subject matter is directed to a bushing for pivotally connecting a beam of a suspension assembly of an axle/suspension system of a heavy-duty vehicle to a hanger depending from a frame of the heavy-duty vehicle. The bushing includes at least one void formed in a body of the bushing that is asymmetrical relative to vertical and horizontal planes extending through a central pivotal axis of the bushing. The form of the asymmetrical void, the positioning of the void in the body of the bushing, and the composition of the bushing provides the bushing with varying conical stiffness relative to varying rotational positions of the bushing. These features enable the bushing to adequately react the various forces encountered by the axle/suspension system during operation of the heavy-duty vehicle, such as vertical, horizontal, lateral, and/or torsional forces, as well as increases the overall roll stiffness of the axle/suspension system, while reducing the resulting roll steer coefficient of the axle/suspension system. This minimizes roll induced steer of the axle/suspension system during body roll events and improves vehicle handling during such events. Moreover, the bushing includes a variable radius in the area adjacent a sleeve disposed through the bushing utilized to pivotally connect the beam of the axle/suspension system to the hanger of the heavy-duty vehicle. This variable radius provides the bushing with relatively uniform cross-sectional thickness in the area adjacent the sleeve when the bushing is installed in the beam of the axle/suspension system, thereby maintaining a greater concentration of bushing material in the load path of the bushing when the bushing is subjected to high radial loads, increasing the snubbing stiffness of the bushing during such high radial loads, and minimizing the potential for the body of the bushing to fold upon itself or crease when subjected to such high radial loads. This reduces the potential for formation of cracks in the body of the bushing, increases the durability and life of the bushing, reduces vehicle down-time, and decreases operational cost of the axle/suspension system, as well as improves the visual quality of the installed bushing. In addition, the bushing is formed via a method that ensures the bushing is formed in a balanced manner, which reduces the potential for removal or washing of adhesive from the sleeve of the bushing from flow of the material forming the bushing during the manufacturing process and improves bonding between the body of the bushing and the sleeve, thereby also increasing the life of the bushing, reducing vehicle down-time, and decreasing operational costs of the axle/suspension system.

The use of air-ride beam-type axle/suspension systems has become popular in the heavy-duty vehicle industry. For purposes of conciseness and clarity, reference shall be made generally throughout to “heavy-duty vehicles” with the understanding that such reference includes trucks, tractor-trailers and semi-trailers, trailers, and the like. Although such axle/suspension systems can be found in widely varying structural forms, in general their structure is similar in that each axle/suspension system typically includes a pair of suspension assemblies. The suspension assemblies are typically connected directly to the primary frame of the heavy-duty vehicle or to a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Each suspension assembly of the air-ride beam-type axle/suspension system includes a longitudinally extending elongated beam. The beam is located adjacent to and below a respective one of a pair of spaced apart longitudinally extending main members, which together with one or more cross members, form the frame or subframe of the heavy-duty vehicle. For purposes of conciseness and clarity, reference shall be made throughout generally to a “main member” with the understanding that such reference includes main members of primary frames, movable subframes and non-movable subframes, and the like. Each beam is pivotally connected at one of its ends to a hanger via a bushing assembly incorporated into the beam end, which typically includes an elastomeric bushing, as is known in the art. The hanger in turn is attached to and depends from a respective one of the main members of the heavy-duty vehicle. Each beam may extend rearward or frontward relative to the front of the heavy-duty vehicle, thus defining what are typically referred to as trailing-arm or leading-arm axle/suspension systems, respectively. However, for purposes of the description contained herein, it is understood that the term “trailing-arm” encompasses beams extending either rearward or frontward with respect to the front end of the heavy-duty vehicle.

An axle extends transversely between and is captured by and typically is irremovably connected to the beams of the pair of suspension assemblies via axle-to-beam connections and associated structure at a selected location from about the mid-point of each beam to the end of the beam opposite the pivotal connection to the hanger. An air spring, or its equivalent, extends between and is connected to the beam at the end of the beam opposite its pivotal connection to the hanger, and in turn is connected to the main member of the frame of the heavy-duty vehicle.

The axle/suspension system generally acts to cushion the ride, dampen vibrations, and stabilize the heavy-duty vehicle. More particularly, as the heavy-duty vehicle is traveling over the road, the wheels of the heavy-duty vehicle may encounter road conditions that impart various forces, loads, and/or stresses, collectively referred to as “forces”, to the respective axle on which the wheels are mounted. In turn, the forces are transferred to the suspension assemblies of the axle/suspension system connected to and supporting the axle. In order to minimize the detrimental effect of these forces on the heavy-duty vehicle as it is operating, the axle/suspension system is designed to react and to minimize or absorb at least a portion of the forces.

The forces include forces along the vertical direction caused by vertical movement of the tires and wheels as they encounter certain road conditions. The forces also include forces along the horizontal direction due to fore-aft or horizontal movement from acceleration, deceleration and braking of the heavy-duty vehicle. The forces further include lateral and torsional forces associated with transverse vehicle movement, such as turning of the vehicle and lane-change maneuvers. In order to address such various forces, axle/suspension systems have differing design and structural requirements.

For example, it is desirable for an axle/suspension system to be fairly stiff in order to minimize the amount of sway experienced by the heavy-duty vehicle and provide roll stability from lateral forces. It is also desirable for the axle/suspension system to be relatively less stiff or flexible to assist in cushioning the heavy-duty vehicle from vertical forces, while providing compliance so that components of the axle/suspension system are able to withstand the vertical forces. It is further desirable to dampen the vibrations or oscillations that result during operation of the heavy-duty vehicle. A key component of the axle/suspension system that cushions the ride of the heavy-duty vehicle from vertical impacts is the air spring, while a shock absorber typically provides damping characteristics to the axle/suspension system. It is known that air springs may also be designed and constructed to provide damping characteristics.

In addition, prior art bushings of the bushing assemblies utilized to pivotally connect the beams of the suspension assemblies of the axle/suspension system to their respective hangers also function to react some of the various forces imparted on the axle/suspension system during operation of the heavy-duty vehicle. More specifically, prior art bushings have been utilized to provide satisfactory management of static loads, roll moments, and braking forces imparted on the bushings. To react these forces, prior art bushings have specific and differing stiffnesses or resistances to deformation in the vertical and horizontal directions in which forces are applied.

More particularly, prior art bushings are designed and constructed to react vertical, horizontal, lateral, and/or torsional forces that are typically encountered during normal operation of the heavy-duty vehicle. The elastomeric body of prior art bushings typically has relatively low stiffness or resistance to compressive forces or deformation in a region that is located in a substantially vertical plane extending through a central pivotal axis of the bushing. To achieve such relatively low stiffness or resistance to compressive forces or deformation in the bushing region that is located in the vertical plane, such prior art bushings typically include a pair of symmetrically oriented voids formed in the body of the bushing, which are positioned within the vertical plane. The bushing has a relatively greater stiffness along the region located in a horizontal plane extending through the central pivotal axis of the bushing. Such bushings typically feature symmetrical stiffness behavior across each of the vertical plane and the horizontal plane.

Such prior art bushings, while generally suitable for their intended purpose, have potential disadvantages, drawbacks, and limitations. More specifically, because such prior art bushings have relatively lower stiffness across the vertical plane due to the symmetrically oriented voids formed in the body of the bushing, as compared to the relatively stiffer area of the bushing located along the horizontal plane, and the bushings provide symmetrical stiffness behavior across each of the vertical plane and the horizontal plane, such prior art bushings potentially do not desirably react body roll forces experienced by the axle/suspension system when utilized in certain heavy-duty vehicle applications and operations. For example, such prior art bushings potentially do not desirably react body roll forces when the prior art bushings are utilized in trailers of multi-combination heavy-duty vehicles, i.e., heavy-duty vehicles that include two or more trailers connected to each other that are pulled by a single heavy-duty semi-truck or prime mover, which are potentially suspectable to relatively decreased handling when experiencing body roll events, as is known. In order to desirably react such body roll events when prior art bushings are utilized in the axle/suspension systems of the trailers of multi-combination vehicles, the overall stiffness of the bushings typically must be increased. However, increasing the overall stiffness of the bushings, and thus the overall roll stiffness of the axle/suspension system, typically increases the overall roll steer coefficient of the axle/suspension system, which can potentially result in undesirable increased roll steer behavior of the axle/suspension system during such a body roll event, as is known. This increased roll steer behavior is especially problematic in trailers of multi-combination vehicles, which can potentially cause the trailers to move undesirably laterally independent of the semi-truck or prime mover, and potentially cause a loss of vehicle control.

Moreover, such prior art bushings may potentially be formed such that they lack uniform cross-sectional thickness in the bushing bodies adjacent the sleeves disposed through the bushings once the bushings are installed in the beams, which can potentially increase the possibility of the bodies of the bushing folding upon themselves or creasing when the bushings are subjected to high radial loads during operation of the heavy-duty vehicle, and can increase the potential for formation of cracks in the bodies of the bushings, as well as can reduce the visual quality of the installed bushings. This can potentially reduce the durability and life of the bushings, increase vehicle down-time, and increase the operational cost of the axle/suspension system employing such prior art bushings.

In addition, such prior art bushings are often formed via manufacturing methods that can potentially undesirably reduce adhesion or bonding of the bodies of the bushings to the sleeves disposed through the bushings. More specifically, such prior art bushings are typically formed via rubber injection molding processes in which uncured elastomeric material is injected into a cavity of a mold in which the sleeves are placed. Adhesive for bonding the sleeves to the elastomeric material forming the bodies of the prior art bushings is applied circumferentially about the radially outward surfaces of the sleeves prior to the sleeves being placed within the cavity of the mold. The elastomeric material forming the prior art bushings is injected into the cavity of the mold through a plurality of sprues located in the mold, which are typically positioned in the mold circumferentially about and relatively close to the radially outward surfaces of the sleeves. As the sprues are positioned relatively close to the radially outward surfaces of sleeves, when the elastomeric material is injected into the cavity of the mold through the sprues to fill the cavity, flow of the elastomeric material over the radially outward surfaces of the sleeves can potentially remove or wash adhesive from the sleeves, resulting in poor bonding between the sleeves and the bodies of the prior art bushings, thereby potentially decreasing durability and the life of the bushings, increasing vehicle down-time, and increasing operational costs of the axle/suspension systems.

Thus, a need exists in the art for a bushing for heavy-duty vehicle axle/suspension systems that adequately reacts the various forces encountered by the axle/suspension system during operation of the heavy-duty vehicle, such as vertical, horizontal, lateral, and/or torsional forces, as well as increases roll stiffness of the axle/suspension system, while reducing the resulting roll steer coefficient of the axle/suspension system, thereby minimizing roll induced steer of the axle/suspension system during body roll events and improving vehicle handling during such events. Moreover, there is a need in the art for a bushing for heavy-duty vehicle axle/suspension systems that includes a relatively uniform cross-sectional thickness in the area adjacent the sleeve disposed through the bushing when the bushing is installed in the beam of the suspension assembly to maintain a greater concentration of bushing material in the load path when the bushing is subjected to high radial loads, increase the snubbing stiffness of the bushing during such high radial loads, and minimize the potential for the body of the bushing to fold upon itself or crease when subjected to such high radial loads, thereby reducing the potential for formation of cracks in the body of the bushing, increasing the durability and life of the bushing, reducing vehicle down-time, and decreasing operational cost of the axle/suspension system, as well as improving the visual quality of the installed bushing. In addition, there is a need in the art for a bushing for heavy-duty vehicle axle/suspension systems that is formed via a method that ensures the bushing is formed in a balanced manner, which reduces the potential for removal or washing of adhesive from the sleeve of the bushing from flow of the elastomer forming the bushing during the manufacturing process and improves bonding between the body of the bushing and the sleeve, thereby also increasing the life of the bushing, reducing vehicle down-time, and decreasing operational costs of the axle/suspension system.

The bushing for heavy-duty vehicle axle/suspension systems of the disclosed subject matter satisfies these needs and overcomes the above described disadvantages, drawbacks, and limitations, and will now be described.

### BRIEF DESCRIPTION OF THE DISCLOSED SUBJECT MATTER

An objective of the disclosed subject matter is to provide a bushing for heavy-duty vehicle axle/suspension systems that adequately reacts the various forces encountered by the axle/suspension system during operation of the heavy-duty vehicle, such as vertical, horizontal, lateral, and/or torsional forces, as well as increases the overall roll stiffness of the axle/suspension system, while reducing the resulting roll steer coefficient of the axle/suspension system.

Another objective of the disclosed subject matter is to provide a bushing for heavy-duty vehicle axle/suspension systems that minimizes roll induced steer of the axle/suspension system during body roll events and improves vehicle handling during such events.

Yet another objective of the disclosed subject matter is to provide a bushing for heavy-duty vehicle axle/suspension systems that includes structure that provides the bushing with relatively uniform cross-sectional thickness in the area adjacent the sleeve disposed through the bushing when the bushing is installed in the beam of the axle/suspension system to maintain a greater concentration of bushing material in the load path of the bushing when the bushing is subjected to high radial loads, increase the snubbing stiffness of the bushing during such high radial loads, and minimize the potential for the body of the bushing to fold upon itself or crease when subjected to such high radial loads.

Another objective of the disclosed subject matter is to provide a bushing for heavy-duty vehicle axle/suspension systems that includes structure which reduces the potential for formation of cracks in the body of the bushing, increases the durability and life of the bushing, reduces vehicle down-time, and decreases operational cost of the axle/suspension system, as well as improves the visual quality of the installed bushing.

Yet another objective of the disclosed subject matter is to provide a bushing for heavy-duty vehicle axle/suspension systems, and a method of forming the same, that is formed in a balanced manner, which reduces the potential for removal or washing of adhesive from the sleeve of the bushing from flow of the material forming the bushing during the manufacturing process and improves bonding between the body of the bushing and the sleeve to increase the life of the bushing, reduce vehicle down-time, and decrease operational costs of the axle/suspension system.

These objectives and others are achieved by the bushing for heavy-duty vehicle axle/suspension systems of the disclosed subject matter, which includes a body formed of an elastomeric material, the body including a central opening passing through the body, the central opening enabling a suspension assembly of the axle/suspension system incorporating the bushing to be pivotally connected to the heavy-duty vehicle; and at least one void formed in the body, the at least one void extending partially circumferentially about an inboard side or an outboard side of the body and being asymmetrically positioned relative to a vertical plane and a horizontal plane extending through a central pivotal axis extending through the central opening when the bushing is installed in a beam of the suspension assembly.

These objectives and others are also achieved by the method of forming a bushing for heavy-duty vehicle axle/suspension systems, which includes the steps of: providing a mold, the mold including a cavity into which a previously uncured elastomeric material can be injected, the mold including a plurality of sprues formed in the mold for injecting the previously uncured elastomeric material into the cavity, the plurality of sprues being arranged into at least two circumferential arrays that are concentrically spaced about the mold; inserting a sleeve into the mold, the sleeve including an adhesive applied circumferentially about a radially outward surface of the sleeve; injecting the previously uncured elastomeric material through the plurality of sprues and into the cavity of the mold; curing the previously uncured elastomeric material injected into the cavity via a suitable curing process to provide a cured bushing; and removing the cured bushing from the cavity of the mold to provide a finished bushing.

### BRIEF DESCRIPTION OF THE SEVERAL VIEWS OF THE DRAWINGS

The exemplary embodiment of the disclosed subject matter, illustrative of the best mode in which applicant has contemplated applying the principles, is set forth in the following description and is shown in the drawings.

FIG. 1 is a fragmentary side elevation view of a portion of a driver-side suspension assembly of a trailing-arm beam-type axle/suspension system that includes a bushing assembly that utilizes a prior art bushing, viewed looking in an outboard direction and showing an axle of the axle/suspension system in cross-section;

FIG. 2 is a perspective view of the prior art bushing utilized with the axle/suspension system shown in FIG. 1, viewed looking in an inboard direction and showing the bushing disposed within a mounting tube of a beam of the suspension assembly of the axle/suspension system;

FIG. 3 is an elevational view of the prior art bushing shown in FIG. 2, viewed looking in an inboard direction and showing the prior art bushing removed from the mounting tube of the beam of the suspension assembly;

FIG. 4 is a cross-sectional view of the prior art bushing shown in FIG. 2, taken approximately along the plane at line 4-4 in FIG. 3;

FIG. 5 is a cross-sectional view of the prior art bushing shown in FIG. 2, taken approximately along the plane at line 5-5 in FIG. 3;

FIG. 6 is a fragmentary perspective view of a portion of a passenger-side suspension assembly of a trailing-arm beam-type axle/suspension system that employs an exemplary embodiment bushing for heavy-duty vehicle axle/suspension systems of the disclosed subject matter, viewed looking in an outboard direction and showing the exemplary embodiment bushing disposed within a mounting tube of a beam of the suspension assembly;

FIG. 7 is a perspective view of the exemplary embodiment bushing shown in FIG. 6, viewed looking in an outboard direction and showing the exemplary embodiment bushing removed from the mounting tube of the beam of the suspension assembly;

FIG. 8 is an elevational view of the exemplary embodiment bushing shown in FIG. 6, viewed looking in an outboard direction;

FIG. 9 is an elevational view of the exemplary embodiment bushing shown in FIG. 6, viewed looking in an inboard direction;

FIG. 10 is a cross-sectional view of the exemplary embodiment bushing shown in FIG. 6, taken approximately along the plane at line 10-10 in FIG. 8; and

FIG. 11 is a cross-sectional view of the exemplary embodiment bushing shown in FIG. 6, taken approximately along the plane at line 11-11 in FIG. 8.

Similar numerals and characters refer to similar components throughout the drawings.

### DETAILED DESCRIPTION OF THE DISCLOSED SUBJECT MATTER

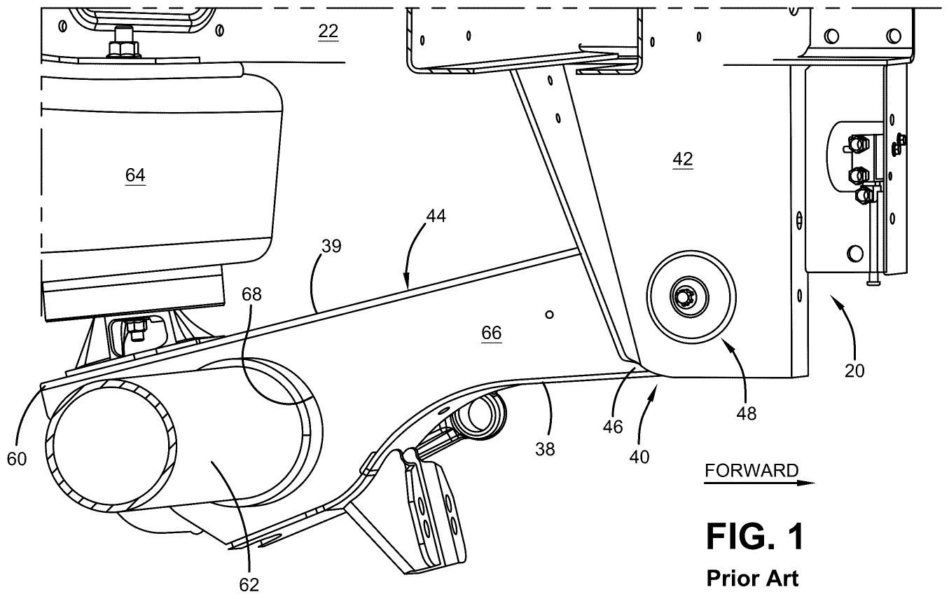

In order to better understand the environment in which the bushing for heavy-duty vehicle axle/suspension systems of the disclosed subject matter is utilized, a trailing-arm beam-type axle/suspension system 20 that utilizes a pair of prior art bushings 50, is shown in FIG. 1. Axle/suspension system 20 includes a pair of transversely or axially spaced mirror-image suspension assemblies 40 that depend from respective longitudinally-extending spaced-apart main members 22 of a frame of a heavy-duty vehicle (not shown). Because axle/suspension system 20 generally includes a substantially similar pair of laterally spaced suspension assemblies 40, for purposes of conciseness and clarity, only one of the suspension assemblies will be described. Suspension assembly 40 includes a trailing-arm beam 44 having a generally rigid metal box-like structure comprising a pair of transversely spaced vertical sidewalls 66. Beam 44 includes a top wall 39 and a bottom plate 38 that extend between and interconnect with sidewalls 66. Sidewalls 66 and top wall 39 are integrally formed as a single-piece that includes an upside down generally U-shaped cross-sectional profile via stamping or bending. Bottom plate 38 is secured to sidewalls 66 via welding or other suitable means.

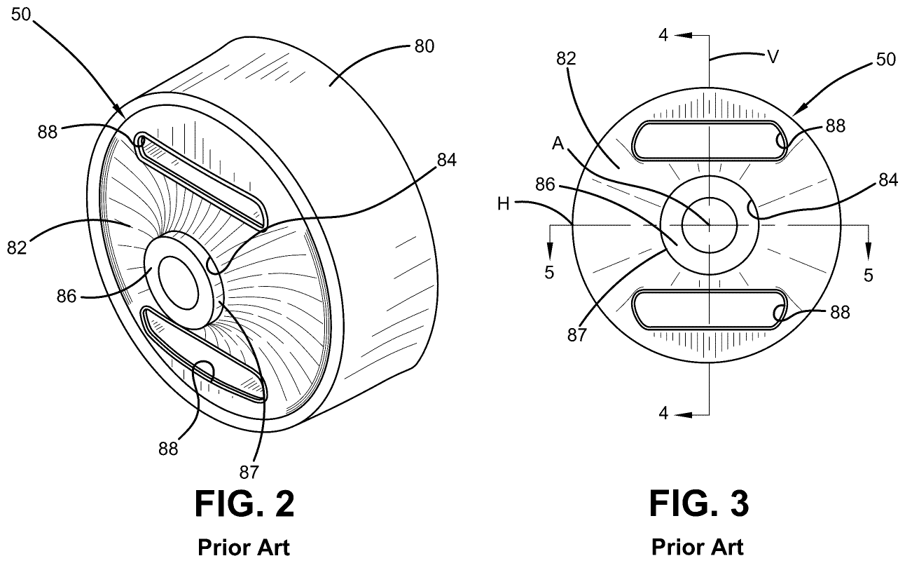

Beam 44 includes a front end portion 46 having a mounting tube 80 (FIG. 2) formed of robust steel that is attached to the front ends of sidewalls 66, bottom plate 38, and top wall 39. A conventional bellows-type air spring 64 is attached to and extends between top wall 39 of beam 44 near a rear end portion 60 of the beam and a respective main member of the heavy-duty vehicle, as is known. An axle 62 extends between and passes through openings 68 (only one shown) formed in sidewalls 66 of beam 44 and is rigidly connected to the sidewalls near rear end portion 60 of each beam. Axle/suspension system 20 may be supplied with shock absorbers (not shown) to provide damping.

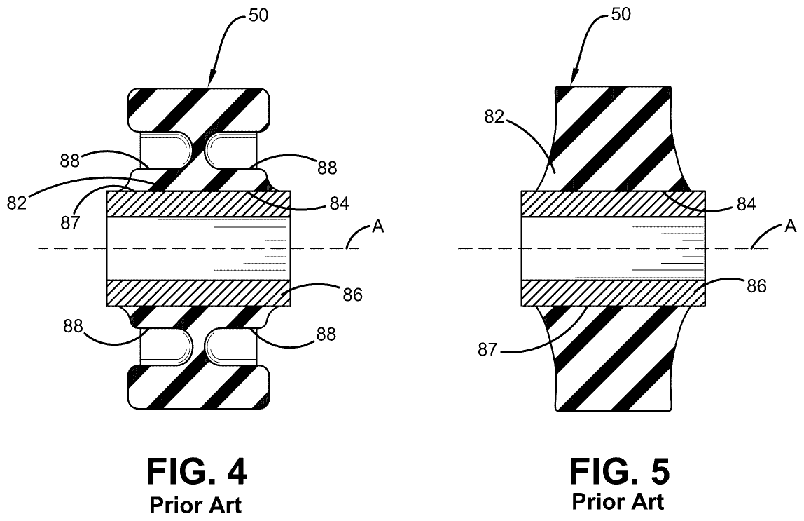

Beam 44 is pivotally mounted via a bushing assembly 48 to a hanger 42, which depends from and is secured to a respective main member of the heavy-duty vehicle. Bushing assembly 48 generally includes prior art bushing 50 (FIGS. 2-5), a pivot bolt (not shown), a pair of wear pads (not shown), and washers (not shown), as is known. With reference to FIGS. 2-5, bushing 50 includes a body 82 that is press-fit into mounting tube 80 (FIG. 2) of beam 44. Body 82 of bushing 50 is formed of an elastomeric material, such as rubber, and is generally cylindrical-shaped. Body 82 is formed with a central opening 84 that passes completely through the body about an axially-extending central pivotal axis A (FIGS. 3-5) of the bushing. With reference to FIGS. 2-4, a pair of circumferentially spaced-apart voids 88 are formed in each inboard and outboard side of body 82. Each of voids 88 is formed in respective top and bottom portions on each side of body 82 such that they are spaced 180° apart and are positioned within a vertical plane V (FIG. 3) extending through central pivotal axis A. With reference to FIG. 4, voids 88 extend axially through a significant portion of body 82 of bushing 50, but do not extend completely through the body. Voids 88 enable bushing 50 of bushing assembly 48 to provide multi-functional characteristics and react the various forces encountered by axle/suspension system 20 during operation of the heavy-duty vehicle, such as those in a vertical direction, a horizontal direction, and an axial direction, as is known in the art.

A rigid metal sleeve 86 is positioned in opening 84 of body 82 of prior art bushing 50 and is retained in the body via a suitable method, such as with an adhesive or mold-bonding. The combined structure of body 82 and sleeve 86 of bushing 50 is then press fit into mounting tube 80 (FIG. 2) of beam 44. Sleeve 86 has a circular tube cross-section taken perpendicular to the central pivotal axis A and is made of any suitable hard metal, such as steel. Sleeve 86 mounts bushing assembly 48 to hanger 42 by passing a bolt (not shown) through the hanger, sleeve, a pair of suitable plastic spacer pads (not shown), and washers (not shown), as is known.

Prior art bushing 50 of bushing assembly 48 provides vertical load-deflection, horizontal load-deflection, and reaction to roll forces. Horizontal load-deflection controls the lateral or side-to-side motion of axle/suspension system 20. With reference to FIG. 3, bushing 50 is relatively stiffer across a horizontal plane H extending though central pivotal axis A than in vertical plane V extending through the central pivotal axis. The multi-functional characteristics of bushing 50 provides required load deflection or absorption of varying levels in different directions. Bushing 50 is relatively stiff across horizontal plane H due to body 82 of the bushing being solid in a direction along the horizontal plane. Thus, axle/suspension system 20 remains substantially perpendicular to the direction of movement of the heavy-duty vehicle despite horizontal loading which may be placed on the axle/suspension system, such as during braking. Bushing 50 is relatively soft along vertical plane V due to the placement and size of voids 88 in body 82 of the bushing. This enables axle/suspension system 20 to absorb vertical loading shocks, such as from a bump or pothole in the road, and provides roll-stability for the heavy-duty vehicle.

While generally suitable for its intended purpose, prior art bushing 50 has potential disadvantages, drawbacks, and limitations. More specifically, because prior art bushing 50 is relatively soft along vertical plane V due to the voids 88 formed in body 82 of the bushing being symmetrically oriented such that they are positioned within the vertical plane, as compared to the relatively stiffer area of the bushing across horizontal plane H, and because the bushing provides symmetrical stiffness behavior across both the vertical plane and horizontal plane, when prior art bushing 50 is utilized in some heavy-duty vehicle applications, the bushing potentially does not desirably react body roll forces experienced by the axle/suspension system(s) in which it is employed. For example, prior art bushing 50 potentially does not desirably react body roll forces when axle/suspension system 20 is utilized in trailers of multi-combination heavy-duty vehicles.

While the overall stiffness of prior art bushing 50 could be increased to adequately react such roll forces during use with such heavy-duty vehicle applications, increasing the overall stiffness of the bushing, and thus the overall roll stiffness of axle/suspension system 20, can potentially undesirably increase the overall roll steer coefficient of the axle/suspension system. This increase in roll steer coefficient is potentially especially problematic when axle/suspension system 20 is employed in trailers of multi-combination vehicles, which can potentially result in undesirable increased roll steer behavior of the axle/suspension system during a body roll event, potentially causing the trailer(s) to move undesirably laterally independent of the semi-truck or prime mover, and potentially result in a loss of vehicle control.

Moreover, prior art bushing 50 may be formed in a manner such that it lacks uniform cross-sectional thickness once installed in beams 44 of suspension assemblies 40 of axle/suspension system 20, which can potentially increase the possibility of the bushing folding upon itself or creasing when the bushing is subjected to high radial loads during operation of the heavy-duty vehicle, thereby increasing the potential for formation of cracks in body 82 of the bushing, reducing the durability and life of the bushing, and increasing vehicle downtime and operational cost of the axle/suspension system, as well as providing poor visual quality of the installed bushing.

In addition, prior art bushing 50 is formed via a manufacturing process that can potentially undesirably reduce bonding of sleeve 86 to body 82 of the bushing. More specifically, prior art bushing 50 is typically formed via a rubber injection molding process in which uncured elastomeric material (not shown) is injected into a cavity (not shown) of a mold (not shown) in which sleeve 86 is placed. An adhesive for bonding sleeve 86 to the elastomeric material forming body 82 of prior art bushing 50 is applied circumferentially about a radially outward surface 87 (FIGS. 2-5) of the sleeve prior to the sleeve being placed within the cavity of the mold. The elastomeric material forming prior art bushing 50 is injected into the cavity of the mold through a plurality of sprues (not shown) located in the mold, which are typically positioned in the mold circumferentially about and relatively close to radially outward surface 87 of sleeve 86. As the sprues are positioned relatively close to radially outward surface 87 of sleeve 86, when the elastomeric material is injected into the cavity of the mold through the sprues to fill the cavity, flow of the elastomeric material over the radially outward surface of the sleeve can potentially remove or wash adhesive from the sleeve, potentially resulting in poor bonding between the sleeve and body 82 of prior art bushing 50, thereby potential decreasing the durability and life of bushing, increasing vehicle down-time, and increasing operational costs of the axle/suspension system.

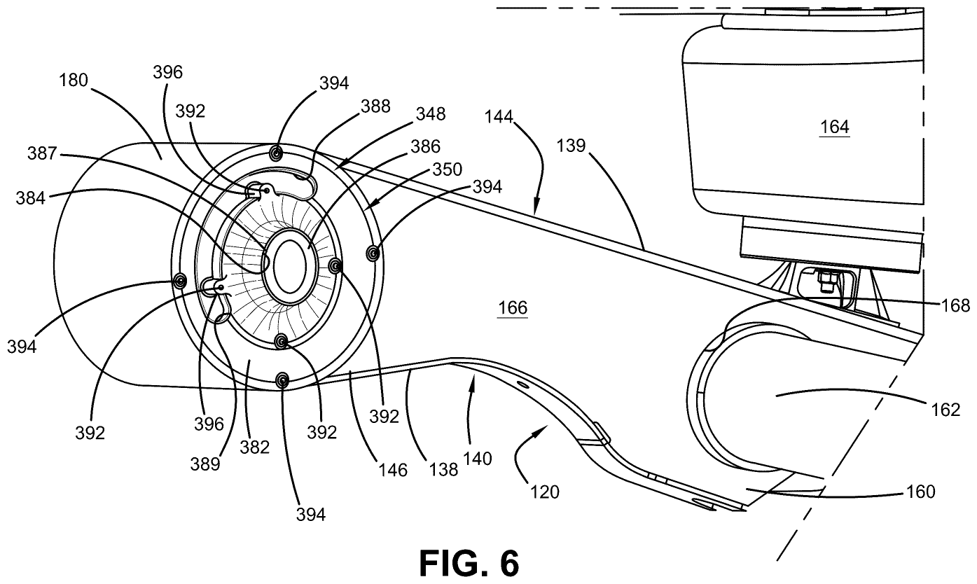

An exemplary embodiment bushing for heavy-duty vehicle axle/suspension systems of the disclosed subject matter is shown in FIGS. 6-11 and is indicated generally at 350. With reference to FIG. 6, exemplary embodiment bushing 350 is employed with a bushing assembly 348 incorporated into a suspension assembly 140 of a trailing-arm beam-type axle/suspension system 120.

Axle/suspension system 120 is similar in structure and function to axle/suspension system 20 (FIG. 1) described above and includes a pair of transversely spaced mirror-image suspension assemblies 140 that depend from respective longitudinally-extending spaced-apart main members (not shown) of a frame of a heavy-duty vehicle (not shown). Because axle/suspension system 120 generally includes a substantially similar pair of transversely spaced mirror-image suspension assemblies 140, for purposes of conciseness and clarity, only one of the suspension assemblies will be described.

Suspension assembly 140 includes a trailing-arm beam 144 having a generally rigid metal box-like structure comprising a pair of transversely spaced vertical sidewalls 166. Beam 144 includes a top wall 139 and a bottom plate 138 that extend between and interconnect with sidewalls 166. Sidewalls 166 and top wall 139 are integrally formed as a single-piece that includes an upside down generally U-shaped cross-sectional profile via stamping or bending. Bottom plate 138 is longitudinally spaced along beam 144 and is secured to sidewalls 166 via welding or other suitable means.

Beam 144 includes a front end portion 146 having a mounting tube 180 formed of a robust material, such as steel, that is attached to the front ends of sidewalls 166, bottom plate 138, and top wall 139. A conventional bellows-type air spring 164 is attached to and extends between top wall 139 of beam 144 near a rear end portion 160 of the beam and a respective main member of the heavy-duty vehicle. An axle 162 extends between and passes through openings 168 (only one shown) formed in sidewalls 166 of each beam 144 and is rigidly connected to the sidewalls near rear end portion 160 of each beam.

Beam 144 is pivotally mounted via bushing assembly 348 to a hanger (not shown), which depends from and is secured to a respective main member of the heavy-duty vehicle. Bushing assembly 348 is generally similar to bushing assembly 48 (FIG. 1) described above in that it includes a pivot bolt (not shown), a pair of wear pads (not shown), and washers (not shown), except that it incorporates exemplary embodiment bushing 350.

With reference to FIGS. 6-11, exemplary embodiment bushing 350 includes an elastomeric body 382 that is press-fit into mounting tube 180 of beam 144. Body 382 is generally cylindrical-shaped and is preferably formed of a relatively soft elastomeric material, such as natural rubber. Body 382 of bushing 350 includes a durometer preferably within the range of about 50 Shore A to about 80 Shore A, more preferably within the range of about 55 Shore A to about 75 Shore A, and most preferably within the range of about 60 Shore A to about 70 Shore A. It is to be understood that body 382 of bushing 350 could be formed of materials other than natural rubber, such as synthetic rubber, without affecting the overall concept or operation of the disclosed subject matter.

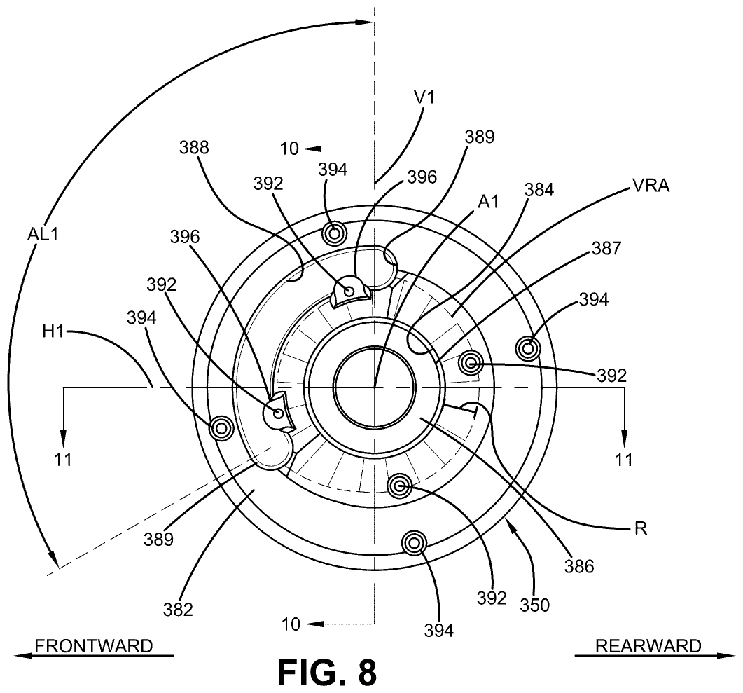

Body 382 of exemplary embodiment bushing 350 is formed with a central opening 384 passing completely through the body about an axially-extending central pivotal axis A1 (FIGS. 8-11) of the bushing. A rigid sleeve 386 is positioned within opening 384 of body 382 of bushing 350 and is retained in the bushing body by suitable means, such as an adhesive. The combined structure of body 382 and sleeve 386 of bushing 350 is press fit into mounting tube 180 of beam 144. Sleeve 386 has a constant diameter tubular cross-section taken perpendicular to central pivotal axis A1. Sleeve 386 is preferably made via a suitable hard metal, such as steel, but could be formed of other materials without affecting the overall concept or operation of the disclosed subject matter. Sleeve 386 mounts bushing assembly 348 to the hanger, and thus beam 144 of suspension assembly 140 to the hanger, by passing the pivot bolt through the hanger, the sleeve, and the pair of wear pads (not shown) and washers (not shown).

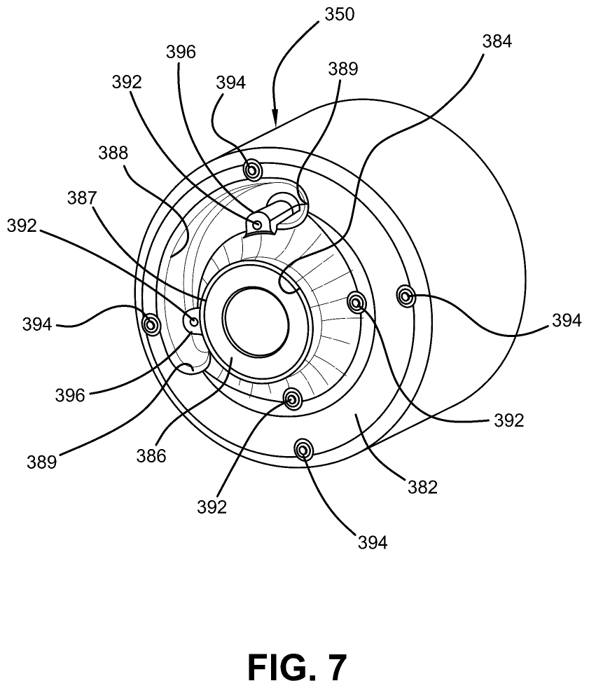

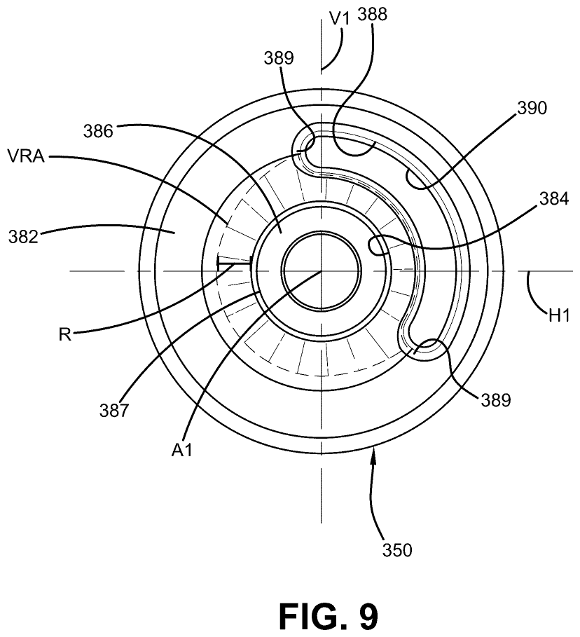

With reference to FIGS. 6-11, body 382 of exemplary embodiment bushing 350 is formed with an arcuate cavity or void 388. Void 388 extends partially circumferentially about body 382 on each of the inboard and outboard sides of bushing 350. Each of the inboard and outboard voids 388 are axially aligned and are substantially similar to one another, except that body 382 of bushing 350 is formed with a pair of columns 396 that extend partially into a radially inward portion of the inboard void, the importance of which will be described in detail below, and the outboard void is formed with an annular ridge 390 (FIGS. 9-11), the importance of which will also be described in detail below. Inasmuch as the inboard and outboard voids 388 are substantially similar to one another, only the inboard void will be described in detail. With particular reference to FIG. 8, void 388 extends partially circumferentially about body 382 of bushing 350 from a position slightly rearward of a vertical plane V1 extending through central pivotal axis A1 (FIGS. 8-11) to a position frontward of the vertical plane and downward of a horizontal plane H1 extending through the central pivotal axis, providing an arcuate extent AL1 of the void. With continued reference to FIG. 8, arcuate extent AL1 of void 388 of exemplary embodiment bushing 350 as shown is 120°. Arcuate extent AL1 of void 388 is preferably within the range of about 90° to about 150°, more preferably within the range of about 110° to about 130°, and most preferably within the range of about 115° to about 125°. Void 388 includes a radiused edge 389 (FIGS. 7-9) at each end of the void. It is to be understood that void 388 could have different shapes than that shown and described without affecting the overall concept or operation of the disclosed subject matter.

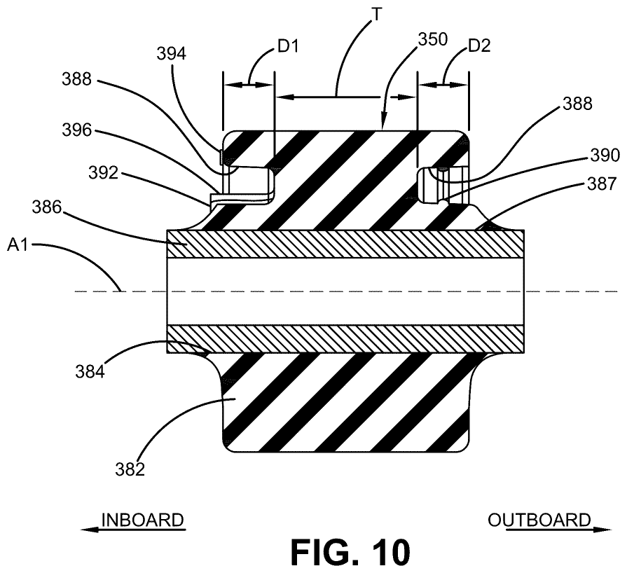

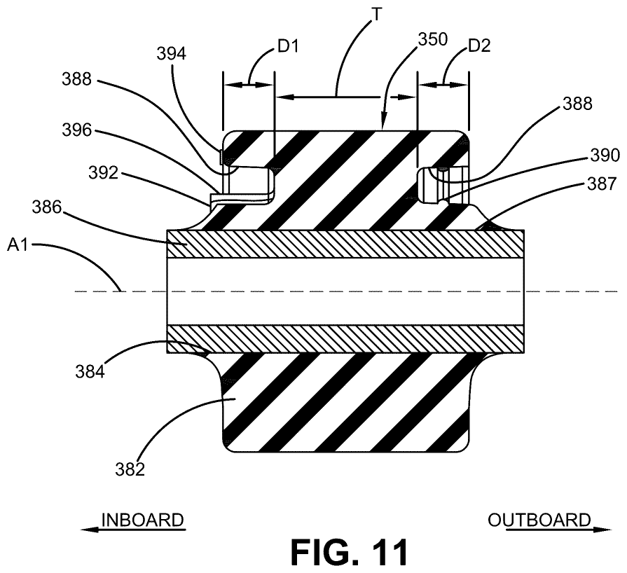

With reference to FIGS. 10-11, each void 388 is relatively shallow, as compared to voids formed in prior art bushings, such as voids 88 of prior art bushing 50 (FIGS. 2-4) described above. More specifically, each inboard and outboard void 388 includes a depth D1 and D2, respectively, preferably within the range of about 10 mm to about 50 mm, more preferably within the range of about 15 mm to about 40 mm, and most preferably within the range of about 20 mm to about 30 mm. While depth D1 and depth D2 of the inboard and outboard voids 388, respectively, are preferably the same, it is contemplated that the depths could be different without affecting the overall concept or operation of the disclosed subject matter. As depths D1 and D2 of the inboard and outboard voids 388, respectively, are relatively shallow, there is relatively more elastomeric material extending axially between the voids as compared to that of prior art bushings, such as bushing 88 (FIGS. 2-5) described above, the importance of which will be described below. With particular reference to FIG. 10, bushing 350 preferably includes a ratio of total void depth of the inboard and outboard voids 388 (defined as D1+D2) to an axial thickness T of the elastomeric material extending axially between the voids within the range of about 0.15 to about 0.85, more preferably within the range of about 0.25 to about 0.70, and most preferably within the range of about 0.35 to about 0.50.

With reference to FIGS. 8-11, void 388 of exemplary embodiment bushing 350 is formed in body 382 of the bushing such that it is asymmetrically positioned relative to vertical plane V1 extending through central pivotal axis A1 of the bushing, as well as is asymmetrically positioned relative to horizontal plane H1 extending through the central pivotal axis of the bushing when the bushing is installed within mounting tube 180 of beam 144 of suspension assembly 140, which provides the bushing with asymmetrical stiffness behavior across both the vertical plane and the horizontal plane, the importance of which will be described in detail below.

In accordance with an important aspect of the disclosed subject matter, the form of void 388, the positioning of the void in body 382 of exemplary embodiment bushing 350, and the composition of the bushing enables the bushing to adequately react the various forces encountered by the axle/suspension system during operation of the heavy-duty vehicle, as well as increases the overall roll stiffness of the axle/suspension system, while reducing the resulting roll steer coefficient of the axle/suspension system. More specifically, because bushing 350 is formed of a relatively soft elastomeric material, and each void 388 of the bushing is asymmetrical relative to vertical plane V1 and horizontal plane H1, and thus provides the bushing with asymmetrical stiffness across both the vertical and horizontal plane, is relatively shallow, and extends partially circumferentially about body 382 of the bushing in the manner described above, the bushing exhibits varying conical stiffness relative to varying rotational positions of the bushing, which enables the bushing to adequately react the various forces, such as vertical, horizontal, lateral, and/or torsional forces, encountered by axle/suspension system 120 during operation of the heavy-duty vehicle. Moreover, because exemplary embodiment bushing 350 includes the aforementioned structure, composition, and features, the overall roll stiffness of axle/suspension system 120 is increased, while the expected resulting roll steer coefficient of the axle/suspension system is decreased, and the axle/suspension system experiences a desirable relatively linear increase in roll steer with increasing roll angles encountered by the axle/suspension system during operational of the vehicle. In this manner, exemplary embodiment bushing 350 minimizes roll induced steer of axle/suspension system 120 during body roll events and improves handling of the heavy-duty vehicle during such events.

In accordance with another important aspect of the disclosed subject matter, and with reference to FIGS. 8 and 9, exemplary embodiment bushing 350 includes a variable radius R in the area of body 382 adjacent sleeve 386 disposed through opening 384, as indicated by area VRA depicted by dashed lines. Variable radius R preferably is within the range of about 5 mm to about 30 mm, more preferably within the range of about 10 mm to about 25 mm, and most preferably within the range of about 15 mm to about 22 mm. Variable radius R provides bushing 350 with relatively uniform cross-sectional thickness in the area of body 382 of the bushing adjacent sleeve 386 when the bushing is press fit or installed within mounting tube 180 of beam 144 of suspension assembly 140. In this manner, a greater concentration of elastomeric material is maintained in the load path of bushing 350 when the bushing is subjected to high radial loads, the snubbing stiffness of the bushing is increased during such high radial loads, and the potential for body 382 of the bushing to fold upon itself or crease when subjected to such high radial loads is minimized, which reduces the potential for formation of cracks in the body of the bushing, thereby increasing the life of the bushing, reducing vehicle down-time, and decreasing operational cost of axle/suspension system 120, as well as improving the visual quality of the installed bushing.

The disclosed subject matter also includes a method of manufacturing, constructing, and/or forming exemplary embodiment bushing 350. More specifically, bushing 350 is preferably formed by a suitable injection molding process, which includes injecting uncured elastomeric material (not shown) into a cavity (not shown) of a mold (not shown) that is formed of a suitable rigid material, such as metal. The mold is preferably a split mold or two-part mold that includes a top half (not shown) and a bottom half (not shown) that comprise the cavity for forming bushing 350. Prior to injecting the elastomeric material into the mold, sleeve 386 is placed within the cavity of the mold, and a suitable amount of adhesive, such as that sold by Parker Hannifin under the brand name Chemlok® 205/6411, is applied circumferentially about a radially outward surface 387 (FIGS. 6-11) of the sleeve. The uncured elastomeric material forming bushing 350 is injected into the cavity of the mold via a plurality of sprues (not shown) located in the mold, such that it substantially surrounds radially outward surface 387 of sleeve 386 and fills the cavity. Once the cavity is filled with an appropriate amount of uncured elastomeric material, the elastomeric material within the cavity is vulcanized or cured via a suitable curing process to form bushing 350. When the mold is a two-part mold, once bushing 350 is cured, the top half of the mold is first removed. Annular ridge 390 formed in the outboard void 388 functions as a die-lock to keep bushing 350 within the bottom half of the mold upon removal of the top half for purposes of convenience and/or safety. Ultimately, bushing 350 is removed from the bottom half of the mold to provide the finished product.

In accordance with yet another important aspect of the disclosed subject matter, exemplary embodiment bushing 350 is formed in a balanced manner, which reduces removal or washing of adhesive from radially outward surface 387 of sleeve 386 of the bushing from flow of the uncured elastomeric material forming the bushing during the manufacturing process, and thus improves bonding between body 382 of the bushing and the sleeve. More specifically, and with reference to FIGS. 6-8 and 10-11, the sprues formed in the mold for injecting the uncured elastomeric material into the cavity of the mold are arranged into at least two circumferential arrays that are concentrically spaced relative to central pivotal axis Al of bushing 350, with one of the arrays being positioned circumferentially about a location of the inboard side of the bushing adjacent the radial outward edge of the bushing, as indicated by outer sprue points 394 (FIGS. 6-8 and 10-11) formed on body 382 of the bushing. The other one of the arrays of sprues formed in the mold for injecting the uncured elastomeric material into the cavity of the mold is positioned circumferentially about a location of the inboard side of bushing 350 radially outward of opening 384 of body 382 of the bushing, as indicated by inner sprue points 392 (FIGS. 6-8 and 10-11) formed on the body of the bushing. Columns 396 of body 382 of bushing 350 are formed via elastomeric material injected into inner sprue points 392 and through corresponding structures formed in the cavity of the mold located partially within the location of the inboard void 388. The corresponding structures formed in the cavity of the mold that form columns 396 enable uncured elastomeric material to be channeled into specific areas within the cavity of the mold to aid in forming bushing 350 in a balanced manner.

As exemplary embodiment bushing 350 is formed via injecting uncured elastomeric material through at least two circumferential arrays of sprues formed in the mold that are positioned relative to the bushing in the locations and manner described above, the bushing is formed in a balanced manner, which reduces removal or washing of adhesive from radially outward surface 387 of sleeve 386 of the bushing from flow of the uncured elastomeric material injected through the sprues, as indicated by inner sprue points 392 and outer sprue points 394 formed in body 382 of the bushing, during the manufacturing process, and improves bonding between the body and the sleeve, thereby increasing the life of the bushing, reducing vehicle down-time, and decreasing operational costs of the axle/suspension system.

Thus, exemplary embodiment bushing for heavy-duty vehicle axle/suspension systems 350 of the disclosed subject matter includes at least one void formed in a body of the bushing that is asymmetrical relative to vertical and horizontal planes extending through a central pivotal axis of the bushing. The form of the asymmetrical void, the positioning of the void in the body of the exemplary embodiment bushing 350, and the composition of the bushing provides the bushing with varying conical stiffness relative to varying rotational positions of the bushing, which enables the bushing to adequately react the various forces encountered by the axle/suspension system during operation of the heavy-duty vehicle, such as vertical, horizontal, lateral, and/or torsional forces, as well as increases the overall roll stiffness of the axle/suspension system, while reducing the resulting roll steer coefficient of the axle/suspension system, thereby minimizing roll induced steer of the axle/suspension system during body roll events and improving vehicle handling during such events. Moreover, exemplary embodiment bushing 350 includes a variable radius in the area adjacent the sleeve disposed through the bushing utilized to pivotally connect the beam of the axle/suspension system to the hanger of the heavy-duty vehicle, which provides the bushing with relatively uniform cross-sectional thickness in the area of the body adjacent the sleeve when the bushing is installed in the beam of the axle/suspension system, thereby maintaining a greater concentration of bushing material in the load path of the bushing when the bushing is subjected to high radial loads, increasing the snubbing stiffness of the bushing during such high radial loads, and minimizing the potential for the body of the bushing to fold upon itself or crease when subjected to such high radial loads. This reduces the potential for formation of cracks in the body of the bushing, increases the durability and life of the bushing, reduces vehicle down-time, and decreases operational cost of the axle/suspension system, as well as improves the visual quality of the installed bushing. In addition, exemplary embodiment bushing 350 is formed via a method that ensures the bushing is formed in a balanced manner, which reduces removal or washing of adhesive from the sleeve of the bushing from flow of the material forming the bushing during the manufacturing process and improves bonding between the body of the bushing and the sleeve, thereby also increasing the life of the bushing, reducing vehicle down-time, and decreasing operational costs of the axle/suspension system.

It is understood that exemplary embodiment bushing for heavy-duty vehicle axle/suspension systems 350 of the disclosed subject matter could be utilized on heavy-duty vehicles having frames or subframes, which are moveable or non-movable, and having one or more than one axle without changing the overall concept or operation of the disclosed subject matter. It is further understood that exemplary embodiment bushing 350 could be utilized with heavy-duty vehicles other than multi-combination vehicles without affecting the overall concept or operation of the disclosed subject matter. It is also contemplated that exemplary embodiment bushing 350 of the disclosed subject matter could be utilized in conjunction with leading- and/or trailing-arm beam-type axle/suspension system designs with bottom-mount/underslung, top-mount/overslung, or top-mount/underslung beams, including beams made of any suitable material, such as metal, metal alloy, composite, and/or combinations thereof, or with different designs and/or configurations than those shown and described, such as solid beams, shell-type beams, truss structures, intersecting plates, spring beams and parallel plates, without changing the overall concept or operation of the disclosed subject matter.

Accordingly, the bushing for heavy-duty vehicle axle/suspension systems of the disclosed subject matter is simplified; provides an effective, safe, inexpensive, and efficient structure and method, which achieve all the enumerated objectives; provides for eliminating difficulties encountered with prior art bushings; and solve problems and obtains new results in the art.

In the foregoing description, certain terms have been used for brevity, clarity, and understanding, but no unnecessary limitations are to be implied therefrom beyond the requirements of the prior art, because such terms are used for descriptive purposes and are intended to be broadly construed. Moreover, the description and illustration of the disclosed subject matter is by way of example, and the scope of the disclosed subject matter is not limited to the exact details shown or described.

Having now described the features, discoveries and principles of the disclosed subject matter; the manner in which the bushing for heavy-duty vehicle axle/suspension systems of the disclosed subject matter is manufactured, constructed, and/or formed, and used and installed; the characteristics of the construction and arrangement; and the advantageous, new and useful results obtained; the new and useful structures, devices, elements, arrangements, parts and combinations, and methods are set forth in the appended claims.

What is claimed is:

1. A bushing for a heavy-duty vehicle axle/suspension system, said bushing comprising:
a body formed of an elastomeric material, said body including a central opening passing through the body, said central opening enabling a suspension assembly of said axle/suspension system incorporating said bushing to be pivotally connected to said heavy-duty vehicle; and
at least one void formed in said body, said at least one void extending partially circumferentially about an inboard side or an outboard side of the body and being asymmetrically positioned relative to a vertical plane and a horizontal plane extending through a central pivotal axis extending through the central opening when said bushing is installed in a beam of said suspension assembly.

2. The bushing for a heavy-duty vehicle axle/suspension system of claim 1, wherein a depth of said at least one void is within a range of about 10 mm to about 50 mm.

3. The bushing for a heavy-duty vehicle axle/suspension system of claim 1, wherein a depth of said at least one void is within a range of about 15 mm to about 40 mm.

4. The bushing for a heavy-duty vehicle axle/suspension system of claim 1, wherein a depth of said at least one void is within a range of about 20 mm to about 30 mm.

5. The bushing for a heavy-duty vehicle axle/suspension system of claim 1, wherein said at least one void has an arcuate extent within the range of about 90° to about 150°.

6. The bushing for a heavy-duty vehicle axle/suspension system of claim 1, wherein said at least one void has an arcuate extent within the range of about 110° to about 130°.

7. The bushing for a heavy-duty vehicle axle/suspension system of claim 1, wherein said at least one void has an arcuate extent within the range of about 115° to about 125°.

8. The bushing for a heavy-duty vehicle axle/suspension system of claim 1, wherein said body is formed with a pair of said at least one voids, each one of said pair of the at least one voids being formed in a respective one of said inboard side or said outboard side of the body and being axially aligned with and substantially similar to the other one of the pair of at least one voids.

9. The bushing for a heavy-duty vehicle axle/suspension system of claim 8, wherein a ratio of a total depth of said pair of at least one voids to an axial thickness of elastomeric material extending axially between the pair of at least one voids in within the range of about 0.15 to about 0.85.

10. The bushing for a heavy-duty vehicle axle/suspension system of claim 8, wherein a ratio of a total depth of said pair of at least one voids to an axial thickness of elastomeric material extending axially between the pair of at least one voids in within the range of about 0.25 to about 0.70.

11. The bushing for a heavy-duty vehicle axle/suspension system of claim 8, wherein a ratio of a total depth of said pair of at least one voids to an axial thickness of elastomeric material extending axially between the pair of at least one voids in within the range of about 0.35 to about 0.50.

12. The bushing for a heavy-duty vehicle axle/suspension system of claim 1, wherein said elastomeric material is natural rubber.

13. The bushing for a heavy-duty vehicle axle/suspension system of claim 1, wherein said body includes a durometer within the range of about 50 Shore A to about 80 Shore A.

14. The bushing for a heavy-duty vehicle axle/suspension system of claim 1, wherein said body includes a durometer within the range of about 55 Shore A to about 75 Shore A.

15. The bushing for a heavy-duty vehicle axle/suspension system of claim 1, wherein said body includes a durometer within the range of about 60 Shore A to about 70 Shore A.

16. The bushing for a heavy-duty vehicle axle/suspension system of claim 1, said bushing further including a sleeve, said sleeve being positioned within and secured to said body about said central opening via suitable means.

17. The bushing for a heavy-duty vehicle axle/suspension system of claim 1, wherein said at least one void includes one or more columns extending partially into a radially inward portion of the at least one void.

18. The bushing for a heavy-duty vehicle axle/suspension system of claim 1, wherein said bushing includes a variable radius in an area of said body adjacent said central opening.

19. The bushing for a heavy-duty vehicle axle/suspension system of claim 18, wherein said variable radius is within the range of about 5 mm to about 30 mm.

20. The bushing for a heavy-duty vehicle axle/suspension system of claim 18, wherein said variable radius is within the range of about 10 mm to about 25 mm.

21. The bushing for a heavy-duty vehicle axle/suspension system of claim 18, wherein said variable radius is within the range of about 15 mm to about 22 mm.

22. The bushing for a heavy-duty vehicle axle/suspension system of claim 1, wherein said at least one void includes an annular ridge, said annular ridge functioning as a die-lock during manufacturing of said bushing.

23. The bushing for a heavy-duty vehicle axle/suspension system of claim 1, wherein said body of said bushing includes a plurality of sprue points, said plurality of sprue points being arranged into at least two circumferential arrays that are concentrically spaced about said inboard side or said outboard side of the body.

24. A method of forming a bushing for a heavy-duty vehicle axle/suspension system comprising the steps of:
a. providing a mold, said mold including a cavity into which a previously uncured elastomeric material can be injected, said mold including a plurality of sprues formed in the mold for injecting said previously uncured elastomeric material into said cavity, said plurality of sprues being arranged into at least two circumferential arrays that are concentrically spaced about the mold;
b. inserting a sleeve into said mold, said sleeve including an adhesive applied circumferentially about a radially outward surface of the sleeve;
c. injecting the previously uncured elastomeric material through the plurality of sprues and into the cavity of said mold;
d. curing said previously uncured elastomeric material injected into said cavity via a suitable curing process to provide a cured bushing; and
e. removing said cured bushing from the cavity of the mold to provide a finished bushing.

25. The method of forming a bushing for a heavy-duty vehicle axle/suspension system of claim 24, wherein said mold is a two-part mold that includes a top half and a bottom half forming said cavity.

26. The method of forming a bushing for a heavy-duty vehicle axle/suspension system of claim 25, wherein said bottom portion includes structure to form a die-lock on said cured bushing upon curing said previously uncured elastomeric material, said step of removing said cured bushing from said cavity of said mold to provide said finished bushing further including the steps of:
i. removing said top half of the mold, said die-lock retaining the cured bushing within said bottom half of said mold upon removal of the top half; and
ii. removing said cured bushing from the bottom half of the mold to provide the finished bushing.
